(19) United States
(12) Patent Application Publication
(10) Pub. No.: US 2020/0019932 A1
(43) Pub. Date: Jan. 16, 2020

(54) TOUCHLESS SUPPLIER INFORMATION MANAGEMENT

(71) Applicant: Coupa Software Incorporated, San Mateo, CA (US)

(72) Inventors: Scott Harris, Menlo Park, CA (US); Ahmad Sadeddin, San Francisco, CA (US); Dmitri Korobov, San Francisco, CA (US)

(21) Appl. No.: 16/506,978

(22) Filed: Jul. 9, 2019

Related U.S. Application Data
(60) Provisional application No. 62/696,726, filed on Jul. 11, 2018.

(51) Int. Cl. G06Q 10/08

(52) U.S. Cl. CPC G06Q 10/0838

(57) ABSTRACT

Touchless supplier information management. A computer-implemented method comprises, before a delayed processing timing has been met, obtaining supplier record data for supplier records created for a particular supplier as a first set of supplier record field values. The supplier records were created based on a previous version of a master supplier record for the particular supplier. The previous version of the supplier record was determined based on a previous set of supplier record data for a previous set of supplier records created for the particular supplier. When the delayed processing timing has been met, a new master supplier record of the particular supplier based on the first set of supplier record field values. A request to create a new supplier record for the particular supplier is received, particular supplier record data is determined based on the new master supplier record for the particular supplier, and the data is provided in response to the request.

### BENEFIT CLAIM

This application claims the benefit of Provisional Application 62/696,726, filed Jul. 11, 2018, the entire contents of which is hereby incorporated by reference as if fully set forth herein, under 35 U.S.C. § 119(e).

### FIELD OF THE DISCLOSURE

One technical field of the present disclosure is computer-implemented software systems that support digital procurement functions. Another technical field is computer-implemented graphical user interfaces, including webpages of a computer-implemented application and automatically modifying supplier record data.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

The operation of server computers and computer application programs adapted to provide electronic digital procurement (e-procurement) and spend management functions has been hampered in the past by inefficient processes to achieve entry of supplier information that is essential to completing digital transactions. For example, an enterprise buyer, who seeks to purchase goods from a supplier by creating a purchase order or requisition for the goods in an e-procurement system, may be unable to complete this operation if the supplier has not previously entered or confirmed the entry of data describing the supplier and its payment processes.

Supplier information necessary to create a complete supplier information management (SIM) record in an e-procurement system or enterprise resource planning (ERP) system includes data relating to names, addresses, international compliance details, banking details, tax details, status under various legal schemes such as whether the supplier is a women-owned business, and so forth. In past approaches, this supplier data for each supplier was collected and entered independently by a variety of buyers and/or suppliers during an on-boarding process. With this past approach, since multiple buyers would independently gather and submit the same supplier information for the same supplier, the duplication of effort resulted in excessive and unnecessarily wasteful use of CPU cycles and network bandwidth.

Based on the foregoing, there is a need to automate batch processing of SIM records and supplier record data to improve computer resource usage with regards to e-procurement transactions.

### SUMMARY

The appended claims may serve as a summary of the invention.

### BRIEF DESCRIPTION OF THE DRAWINGS

FIG. 1 illustrates an example networked computer system in which various embodiments may be practiced.

FIG. 2 illustrates a device message flow, in an example embodiment.

FIG. 3 illustrates an algorithm or method for batch processing supplier records, in an example embodiment.

FIG. 4 illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form to avoid unnecessarily obscuring the present invention.

Embodiments are described in sections according to the following outline:
1.0 GENERAL OVERVIEW
2.0 STRUCTURAL OVERVIEW
3.0 FUNCTIONAL OVERVIEW
4.0 PROCEDURAL OVERVIEW
5.0 HARDWARE OVERVIEW

### 1.0 General Overview

E-procurement control computer systems allow entities to reduce the consumption of data processing resources involved in the purchasing processes by batch processing supplier records and generating new master supplier records. This disclosure focuses on technical improvements in such e-procurement control systems. In one embodiment, an e-procurement control system implemented as an online, networked Software-as-a-Service (SaaS) system is disclosed. The e-procurement control system may be implemented using a virtualized data center that hosts or executes a plurality of instances of the system, to which multiple different entities or tenants connect. A shared multi-tenant database may be accessible to the e-procurement control system for purposes of secure storage of different data of unrelated or competing entities or tenants.

In some embodiments, a master supplier record is a record of a particular supplier that represents a consensus determined from multiple supplier records for that particular supplier. For example, the multiple supplier records (which may originate from multiple different third-party ERP systems) may have missing or wrong data elements about the particular supplier, including for example mismatching or outdated payment terms, contact information, tax identification numbers and purchase order transmission e-mail addresses. This result is that the multiple supplier records having mismatching information and outdated supplier information. The master supplier record for a particular supplier may be used as a record the particular supplier in the system with any mismatching and outdated information issues resolved based on consensus of the information among the multiple supplier records. For example, if there are five supplier records from five different third-party ERP systems for the same supplier and four of those five records have the same tax identification number for the supplier, then the master supplier record for the supplier may contain that tax identification number instead of the one that differs from the other four supplier records.

In an embodiment, methods and computer systems are provided that are programmed or configured to enable computing efficiency by batch processing supplier records and generating new master supplier records. The new master supplier records are used to determine particular supplier record data that is provided in response to a request. Previous approaches involved repeatedly obtaining the same data, resulting in excessive and wasteful use of processing resources such as CPU cycles, memory, and network bandwidth. However, the present approach uses a master record in association with batch processing of supplier records to reduce the duplication of efforts and decrease the use of computer resources, thus improving overall e-procurement computing system efficiency.

In an embodiment, a computer implemented method comprises obtaining supplier record data for supplier records created for a particular supplier as a first set of supplier record field values while a delayed processing timing has not been met. The supplier records were created based, at least in part, on a previous version of a master supplier record for the particular supplier. The previous version of the master supplier record was determined, at least in part, based on a previous set of supplier record data for a previous set of supplier records created for the particular supplier. The method further comprises, when the delayed processing timing has been met, determining a new master supplier record for the particular supplier based, at least in part, on the first set of supplier record field values. The method further comprises receiving a request to create a new supplier record for the particular supplier and determining particular supplier record data based, at least in part, on the new master supplier record for the particular supplier. The method further comprises providing the particular supplier record data in response to the request. The method is performed by one or more computing devices.

### 2.0 Structural Overview

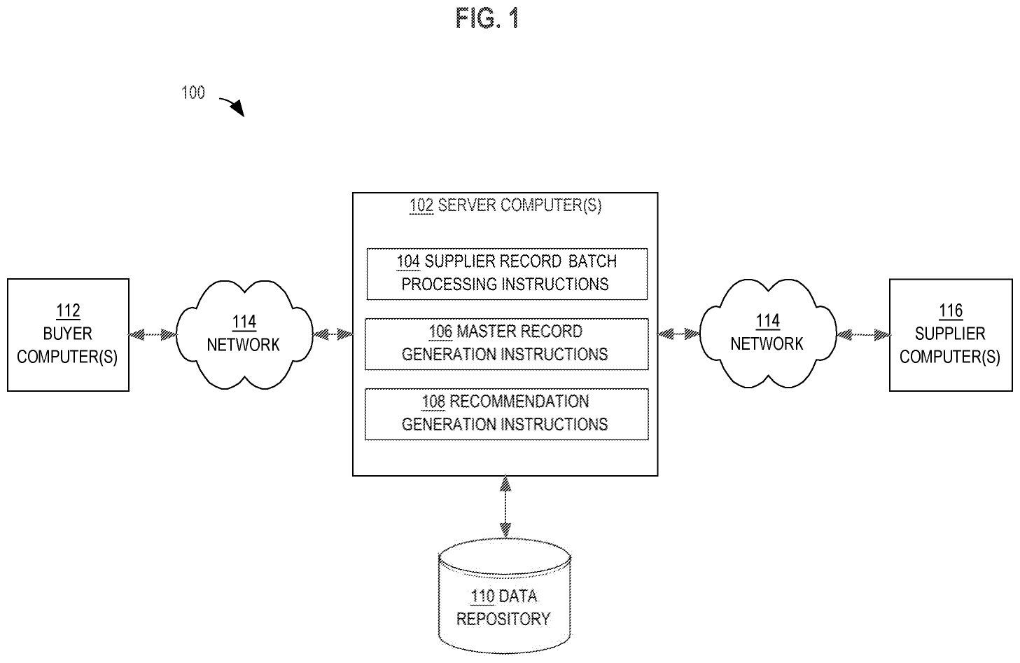

FIG. 1 is a block diagram of an example computer network system in which various embodiments may be practiced. In an embodiment, a computer system 100 comprises components that are implemented at least partially by hardware at one or more computing devices, such as one or more hardware processors executing program instructions stored in one or more memories for performing the functions that are described herein. All functions described herein are intended to indicate operations that are performed using programming in a special-purpose computer or general-purpose computer, in various embodiments. A “computer” may be one or more physical computers, virtual computers, and/or computing devices. As an example, a computer may be one or more server computers, cloud-based computers, cloud-based cluster of computers, docker containers, virtual machine instances or virtual machine computing elements such as virtual processors, storage and memory, data centers, storage devices, desktop computers, laptop computers, mobile devices, and/or any other special-purpose computing devices. Any reference to “a computer” herein may mean one or more computers, unless expressly stated otherwise.

Computer executable instructions described herein may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. In another embodiment, the programmed instructions also may represent one or more files or projects of source code that are digitally stored in a mass storage device such as non-volatile RAM or disk storage, in the systems of FIG. 1 or a separate repository system, which when compiled or interpreted cause generating executable instructions which when executed cause the computer to perform the functions or operations that are described herein with reference to those instructions. In other words, the drawing figure may represent the manner in which programmers or software developers organize and arrange source code for later compilation into an executable, or interpretation into bytecode or the equivalent, for execution by computer(s).

FIG. 1 illustrates only one of many possible arrangements of components configured to execute the programming described herein. Other arrangements may include fewer or different components, and the division of work between the components may vary depending on the arrangement. In the example of FIG. 1, a networked computer system 100 may facilitate the exchange of data between server computer(s) 102, buyer computer(s) 112, and supplier computer(s) 116. Therefore, each of elements 102, 112, and 116 of FIG. 1 may represent one or more computers that host or execute stored programs that provide the functions and operations that are described further herein in connection with e-Procurement services. The methods and systems describe herein may be designed to accommodate a variety of different enterprises.

In an embodiment, a networked computer system 100 comprises server computer(s) 102, or server, buyer computer(s) 112, and supplier computer(s) 116, which are communicatively coupled directly or indirectly via network 114.

Server computer 102 may be implemented using a server-class computer or other computers having one or more processor cores, co-processors, or other computers. Server computer 102 may be a computer, software and/or hardware or a combination storing instructions that are programmed or configured to store, process, analyze, and send transaction data in order to generate recommendations. The server computer 102 may additionally receive information that is not specific to individual transactions, such as public contact information of suppliers, website URLs for suppliers, and catalogue information for suppliers.

In an embodiment, the server computer 102 executes, in association with an e-procurement system, supplier record batch processing instructions 104, master record generation instructions 106, and recommendation generation instructions 108, the functions of which are described in other sections herein. The supplier record batch processing instructions 104, master record generation instructions 106, and recommendation generation instructions 108 may be computer instructions installed separately from or as a part of the e-procurement system, as a module or a plug-in to supplement features of the e-procurement system, as a separate instance of executing code on the server computing device 102 than an instance of code of the e-procurement system, or any other arrangement depending on the needs of a buyer entity.

The supplier record batch processing instructions 104 may cause the server computer 102 to batch processes multiple supplier records featuring supplier record data in rounds. For example, supplier record batch processing instructions 104 may include features to access existing records or data from the database 110, access supplier data from external sources, and transmit or receive data to and from buyer computers 112 and supplier computers 116 in order to access and process updated supplier data. The supplier record batch processing instructions 104 may also be used for implementing aspects of the flow diagrams that are further described herein. For example, the supplier record batch processing instructions 104 may access a system clock to monitor for a delayed processing time.

The master record generation instructions 106 may be cause the server computer 102 to generate updated master supplier records based on data obtained using the supplier record batch processing instructions 104. For example, master record generation instructions 106 may include features to determine new master supplier records for a particular supplier based on field values of supplier records that are obtained using the supplier record batch processing instructions 104. The master record generation instructions 106 may also be used for implementing aspects of the flow diagrams that are further described herein. For example, the master record generation instructions 106 may access a system clock to monitor for a delayed processing time.

While in some embodiments the delayed processing time is met by the expiration of a timer or met when a clock has reached a predetermined clock time or met when a predetermined threshold amount of time has passed since a last update time associated with a master supplier record, the delayed processing time is met upon detecting the occurrence of a particular non-time-based triggering event within the system in other embodiments. The non-time-based triggering event may be an event that occurs within the system that is not time-based. For example, the non-time-based triggering event may be user input to the system to command the system to generate updated master supplier records.

The recommendation generation instructions 108 may cause the server computer 102 to generate custom recommendations for particular supplier record data. For example, the recommendation generation instructions 108 may include features to receive requests to create new supplier records and generate recommendations for supplier record fields in conjunction with the supplier record batch processing instructions 104 and master record generation instructions 106. The recommendation generation instructions 108 the database 110 to provide these recommendations. The recommendation generation instructions 108 may also be used for implementing aspects of the flow diagrams that are further described herein.

The server computer 102 may be associated with database 110. The database 110 may store transactional information on one or more supplier entities as well associated details on the supplier entities. The database 110 may also include, a master supplier record featuring supplier-specific data that has been gathered for each supplier, as further discussed herein. The database 110 may also include, for each supplier entity, one or more records of orders or transactions between the buyer entity and a respective supplier entity along with confidence values, recency values, frequency values, and any other values associated with the data. Additional computing elements, code or other functional elements that are not shown in FIG. 1 may be provided in association with the server computing device 102.

Network 114 broadly represents a combination of one or more wired or wireless networks, such as local area networks (LANs), wide area networks (WANs), metropolitan area networks (MANs), global interconnected internetworks, such as the public internet, or a combination thereof. Each such network may use or execute stored programs that implement internetworking protocols according to standards such as the Open Systems Interconnect (OSI) multi-layer networking model, including but not limited to Transmission Control Protocol (TCP) or User Datagram Protocol (UDP), Internet Protocol (IP), Hypertext Transfer Protocol (HTTP), and so forth. All computers described herein may be configured to connect to the network 140 and the disclosure presumes that all elements of FIG. 1 are communicatively coupled via network 114. The various elements depicted in FIG. 1 may also communicate with each other via direct communications links that are not depicted in FIG. 1 for purposes of explanation.

The server computing device 102 is accessible over network 114 by multiple computing devices, such as a buyer computing device 112 or a supplier computing device 116. Any other number of buyer computing devices 112 or supplier computing devices 116 may be registered with the server computer 102 at any given time. Thus, the elements in FIG. 1 are intended to represent one workable embodiment but are not intended to constrain or limit the number of elements that could be used in other embodiments.

The computing devices such as the buyer computer 112 and supplier computer 116 may comprise a desktop computer, laptop computer, tablet computer, smartphone, or any other type of computing device that allows access to the server computer 102. The buyer computer 112 may be associated with one or more buyers. The supplier computer 116 may be associated with one or more suppliers.

### 3.0 Functional Overview

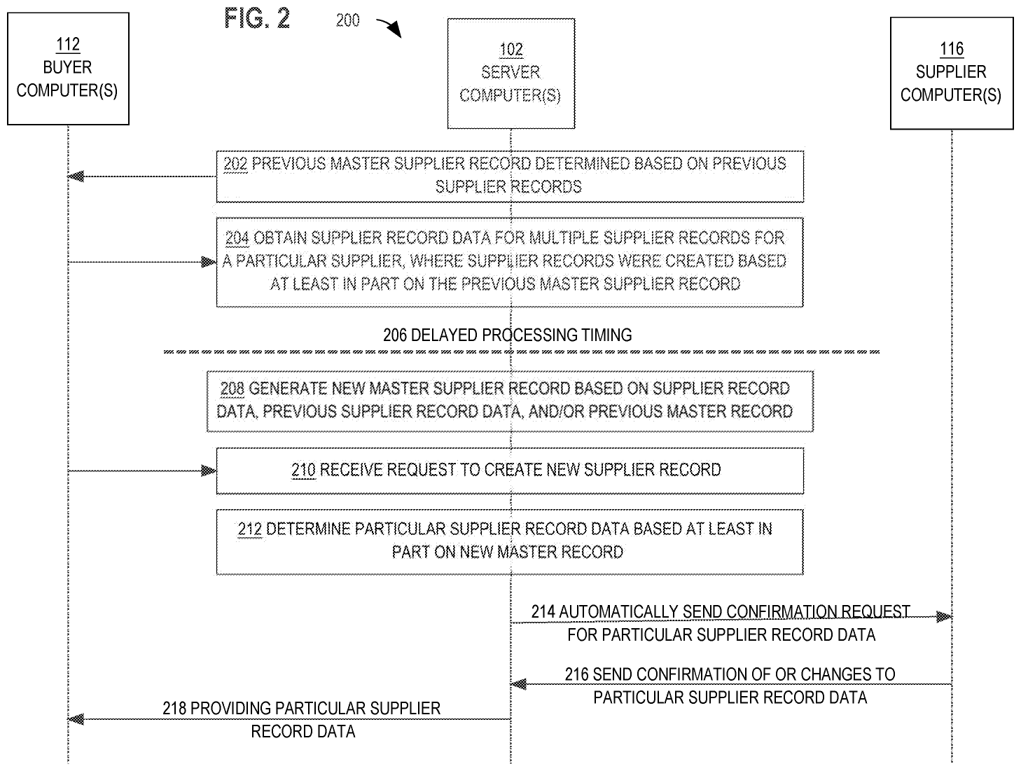

FIG. 2 illustrates a device message flow 200 between one or more buyer computers 112, one or more supplier computers 116 and one or more server computers 102, in an example embodiment. Communication between devices may be implemented through a e-procurement system configured to onboarding customers by obtaining and processing supplier data, in an example embodiment.

For purposes of illustrating a clear example, FIG. 2 is described herein in the context of FIG. 1, but the broad principles of FIG. 2 can be applied to other systems having configurations other than as shown in FIG. 1. Further, FIG. 2 and each other diagram herein illustrates an algorithm or plan that may be used as a basis for programming one or more of the functional modules of FIG. 1 that relate to the functions that are illustrated in the diagram, using a programming development environment or programming language that is deemed suitable for the task. Thus, FIG. 2 and each other diagram herein are intended as an illustration at the functional level at which skilled persons, in the art to which this disclosure pertains, communicate with one another to describe and implement algorithms using programming. The flow diagrams are not intended to illustrate every instruction, method object or sub step that would be needed to program every aspect of a working program, but are provided at the high, functional level of illustration that is normally used at the high level of skill in this art to communicate the basis of developing working programs.

At step 202 of the device message flow 200, before a delayed processing timing 206 has been met, the server computer 102 may execute supplier record batch processing instructions 104 to access previous master supplier records that have been determined based on previous supplier records. These master supplier records for particular suppliers may be stored in a data repository 110 associated with the server computer 102. Data from the previous master supplier records may be sent to buyer computers 112 while onboarding customers. For example, the server computer 102 may use previous master supplier records for Supplier A, Supplier B, and/or Supplier C to provide data about Supplier A, Supplier B, and/or Supplier C to one or more buyer computers 112 based on previous supplier records submitted for Supplier A, Supplier B, and/or Supplier C. The buyer computers 112 then generate multiple supplier records featuring supplier record data about Supplier A, Supplier B, and/or Supplier C and sends the supplier record data to the server computer 102.

At step 204, server computer 102 may use the supplier record batch processing instructions 104 to obtain supplier record data for multiple supplier records for a particular supplier. For example, a first buyer computer 112 may send a first supplier record containing current data about the Supplier A to the server, while a second buyer computer 112 sends a second supplier record also containing data about Supplier A to the server. The server computer 102 may subsequently use these supplier records pertaining to Supplier A to generate a master supplier record for Supplier A. The server computer 102 may receive any number of supplier records featuring data that pertains to any number of suppliers from any number of buyer computers 112 before the delayed processing timing 206 is met.

In an embodiment, these supplier records were created based, at least in part, on the previous master supplier records. In the example above, the two supplier records for Supplier A may have been generated, at least partially, using previous master supplier record data for Supplier A. In an embodiment, the server computer 102 may have provided previous master supplier record data to the buyer computers 112 at step 202, which the buyer computers 112 used to generate various supplier records featuring supplier record data about specific suppliers. The previous master supplier record data may have been altered or added to using the buyer computer 112 to generate the supplier record.

At step 206, the delayed processing timing is met. Subsequently, at step 208, the server computer 102 uses master record generation instructions 106 to generate a new master record for particular suppliers. Any combination of current and past data may be used to generate the new master record. For example, the new master record for a particular supplier may be generated based on the supplier record data associated with the supplier records obtained at step 204. The new master record for the particular supplier may also be generated based on the previous supplier record data and/or the previous master record data discussed in step 202. In an embodiment, the new master record may feature updated data obtained from the supplier record or a combination of updated data from the supplier record, as well as previous data from the previous master supplier record and/or previous supplier records. The new master record may be stored in the data repository 110 associated with the server computer 102 and subsequently used for future onboarding. In an embodiment, the new master record may replace the previous master supplier record in steps 202 and 204 for future processes.

At step 210, the server computer 102 receives a request to create a new supplier record from the buyer computer 112. Subsequently, at step 212, in response to receiving this request, the server computer 102 may use recommendation generation instructions 108 to determine particular supplier record data based at least in part on the new master record. For example, a buyer computer 112 may send a request to create a new supplier record for Supplier A during customer onboarding. The server computer 102 may receive this request and access the new master supplier record for Supplier A that is stored in the data repository 110. The server computer 102 may execute recommendation generation instructions 108 to determine Supplier A data to recommend based on the new master record for Supplier A.

In an embodiment, once the server computer 102 determines the particular supplier data, the server may send the data directly to the buyer computer 112 that originally sent the request to create a new supplier record, as depicted by step 218. In another embodiment, once the server computer 102 determines the particular supplier data, the server computer 102 may, at step 214, automatically send a confirmation request to a supplier computer 116 to request confirmation of the particular supplier record data. In response, the supplier computer 116 may send a response that either confirms or changes the data at step 216. For example, Supplier A may use supplier computer 116 to receive a confirmation request featuring particular Supplier A data determined at step 212. If the data is determined to be correct, the supplier computer 116 may send a confirmation response through a one-click confirmation, in an example embodiment. In another embodiment, the supplier computer 116 may change or update the supplier data with new data, which is sent to the server computer 102. Subsequently, at step 218, the server computer 102 may receive the response changing the data and send the data to the buyer computer 112. In an embodiment, the confirmation or changes received may be used in subsequently supplier record and/or master supplier record determinations.

Supplier onboarding is further described in provisional application No. 62,446,864, filed Jan. 17, 2017, and non-provisional application Ser. No. 15/714,822, filed Sep. 25, 2017, the entire contents of which are incorporated by reference as if fully disclosed herein.

In some embodiments, the server computer 102 is programmed or configured with data structures and/or database records that are arranged to allow a buyer computer 112 to create, update, or delete a workflow linking forms related to ecommerce transactions. The server computer 102 is programmed or configured to preselect or prebuild a set of forms, each corresponding to a task and generally containing one or more fillable fields. More specifically, a “form,” in this context, refers to a combination of a form name value and a set of program instructions and/or structured markup language template instructions that collectively can be used to render a panel, window, web page, portion of a web page, or other displayable element of an online, web-based application program. An example of a form is a data entry form within a dynamically generated web page that is programmed for receiving supplier information to convey to a database record of an e-procurement program. Such a form can be processed by a buyer computer 112 or a supplier computer 116 through displaying data in the form for user review or collecting data locally or from a user to fill out the fields in the form. The fields could be for bibliographical data, transactional detail, indication of approval or disapproval, etc. Such a form would also be associated with a class representing one side of an e-commerce transaction who is to process the form, such as a buyer class or a supplier class.

For example, one form can be a (1) “new supplier request form” used by a buyer computer 122 for initially requesting onboarding of a new supplier into a corresponding CRM system. This form can contain fields for information regarding the requester, reasons for the request, name of the supplier, or due date or expiration date of the request.

Another form can be a (2) “new supplier request approval form” used by the buyer computer 122 to internally approve or disapprove the request. This form can contain a summary of information on the (1) “new supplier request form” and fields for information regarding the request reviewer, the review date, or the review result (approval or disapproval).

Yet another form can be a (3) “new supplier information request form” used by a supplier computer 116 to provide the supplier's onboarding information. This form can contain fields for information regarding the supplier's bank account, commodity, electronic transaction preferences, minority ownership, or contact details.

The server computer 102 can be programmed to allow the buyer computer 112 to customize each of these forms, or create one from scratch, by creating brand new fields or selecting one or more of the available fields. For example, the buyer computer 112 can create a new form by requesting addition, deletion, or relabeling of a field of an existing form, rearrangement of the fields of the existing form, and so on.

In some embodiments, the server computer 102 is programmed or configured with data structures and/or database records that are arranged to can prebuild workflows linking forms related to ecommerce transactions. For example, one workflow may comprise the processing of the (1) “new supplier request form” followed by the processing of the (2) “new supplier request approval form”, followed by the processing of the (3) “new supplier information request form”, as discussed above. The server 102 can then allow a buyer computer 112 to customize these workflows, or create new ones from scratch. For example, the buyer computer 112 can be configured to create a new workflow by requesting addition or deletion of a form in an existing workflow, or assembling existing forms into a workflow. For assembling existing forms into a workflow, the server 102 is programmed or configured to allow a buyer computer 112 to build a workflow incrementally by linking two forms and repeating this process to expand the workflow with additional forms. Additional workflows can be built by linking relevant forms in various manner, such as bidirectional linking or conditional linking.

In an embodiment, an e-procurement application program or server computer is programmed to perform the following additional functions. Entering a new supplier name that is unrecognized in the e-procurement system, based on queries to its database, prompts the user computer to start entering data in a new supplier form. When the new supplier form is completed, data relating to new suppliers enters a draft state or suspended state. For suppliers in the draft state or suspended state, user computers cannot create or invoke purchase orders or other similar operations that result in an order or transaction, but user computers can initiate and perform administrative operations. In some embodiments, a transaction can be initiated, but not completed.

The draft state or suspended state is maintained until the data for a new supplier, entered in the new supplier form, is transmitted to a separate enterprise resource planning (ERP) system for validation and confirmation. In response to receiving a confirmation signal from the ERP system, the e-procurement system may complete activating the supplier and purchase orders can be entered thereafter. Thus, confirmation from the ERP system is a requirement for activation. The ERP system is considered a “source of truth” system for suppliers that are used in the e-procurement system and the supplier record in the e-procurement system is confirmed from that other system.

In one embodiment, after filling out a first supplier data form, a supplier record is created in the e-procurement system with an Onboarding status. The supplier record is linked to a SIM record in the ERP system. The link of the supplier record to the SIM record permits automatic synchronization between the e-procurement system and the external ERP system. Thus, in an embodiment, when a verification signal is received back from the ERP system at the e-procurement system, the e-procurement system may be programmed to automatically update the supplier record as CONFIRMED or with a similar status that is not suspended, and to signal the buyer computer to continue the purchase order or contract workflow that was interrupted to obtain the supplier data. This allows transactions to automatically advance once supplier information is confirmed or received back from the ERP system. The buyer computer is not required to search for the supplier or determine when to continue the process; the purchase order (PO) or contracts process continues automatically without manual invocation by the buyer computer.

The process described in this disclosure may initiate in response to operations other than creating a purchase order. Example operations that initiate supplier information creation may include: a buyer who is initiating a purchase who enters a supplier name in creating a requisition; entering a requisition; contract renewal; using a free form requisition line; non PO backed invoicing (with PO, there is already a supplier); contract creation. In an embodiment, any of these operations, when a specified supplier is unrecognized, causes the supplier setup process described herein to initiate. Thus, the SIM collection process is effectively inserted inline with a free-form requisition process or contracts process that can have any number of steps or any specific workflow. Yet another example is initiating a sourcing event with one or more suppliers who are not known; in an embodiment, this process also initiates intake of a supplier as a Quote Supplier or Source Supplier.

In an embodiment, the purchase workflow from the buyer's side proceeds in steps consisting of REQUISITION→APPROVAL→PURCHASE ORDER. In an embodiment, supplier information management (SIM) as described herein is performed at the REQUISITION stage and when the SIM process is complete, control transfers back to the APPROVAL state.

In one embodiment, the SIM process causes transmitting, to a specified e-mail address of a supplier, an e-mail message containing hyperlinks that invoke operation of the e-procurement system at specified dynamic web pages or forms that are programmed to receive data from the supplier, regardless of whether the supplier holds an account in the e-procurement system. For example, initiating a requisition and specifying an unrecognized supplier may cause the e-procurement system to prompt a user to enter at least an e-mail address for the new supplier. In response, the e-procurement system dispatches an e-mail message that contains hyperlinks acting as callbacks into the e-procurement system. When the e-mail is opened and the hyperlinks are selected, a supplier computer (separate from the buyer) receives a dynamically generated web page or form in which to enter or confirm data.

The page or form may vary according to other attributes that the buyer has specified. For example, there can be a form with basic contact information, tax information and banking information, or other more complex forms or separate forms for specified data such as EU VAT identifier. The e-procurement system may digitally store and manage, in a database or other repository, a mapping of different forms, pages or links to different starting locations within the e-procurement system. Using the mapping, the e-procurement system is programmed to control which form is dispatched to a new supplier based on initial input from the buyer computer. In an embodiment, the mapping has: name, source easy form, response easy form and email. The table controls restrictions like only one mapping per source form. The page or form defines what information is to be collected from the supplier. A particular supplier can be represented in the system as multiple different vendors and response data from the supplier can be mapped to the vendor.

The process has the technical benefit of eliminating database queries or other administrative computer operations relating to checking which suppliers are in the onboarding state or have been manually contacted by e-mail or phone and whether they have responded, provided all data, provided partial data, etc.

In an embodiment, the process herein will interrupt a purchase transaction to alert the buyer that supplier information is missing or stale and needs updating. For an existing supplier where the existing data is stale, the buyer is notified that an update has not occurred, and they may want to request updated supplier information. If the buyer elects to generate a request, then the supplier is notified and requested to update its data. Stale data, in this context, can mean data not updated or confirmed for a specified number of months such as 3, 6, 12, etc. The e-procurement system also may be programmed to check the status of SIM data at other times in a transaction.

The process reduces or eliminates the manual transactions that have been previously required to gather data and reduces errors. Further, based on the received information, the next form may be automatically selected and used.

In an embodiment, once a supplier entity is onboarded in the e-procurement system, a buyer computer may access details associated with the supplier entity by browsing and exploring different supplier entities through the e-procurement system. A buyer computer 112 may also access details associated with the supplier entity when creating a purchase order in association with a supplier entity. Browsing and exploring different supplier entities is discussed in U.S. application Ser. No. 15/815,497, filed Nov. 16, 2017, the entire contents of which are incorporated by reference as if fully disclosed herein.

### 4.0 Procedural Overview

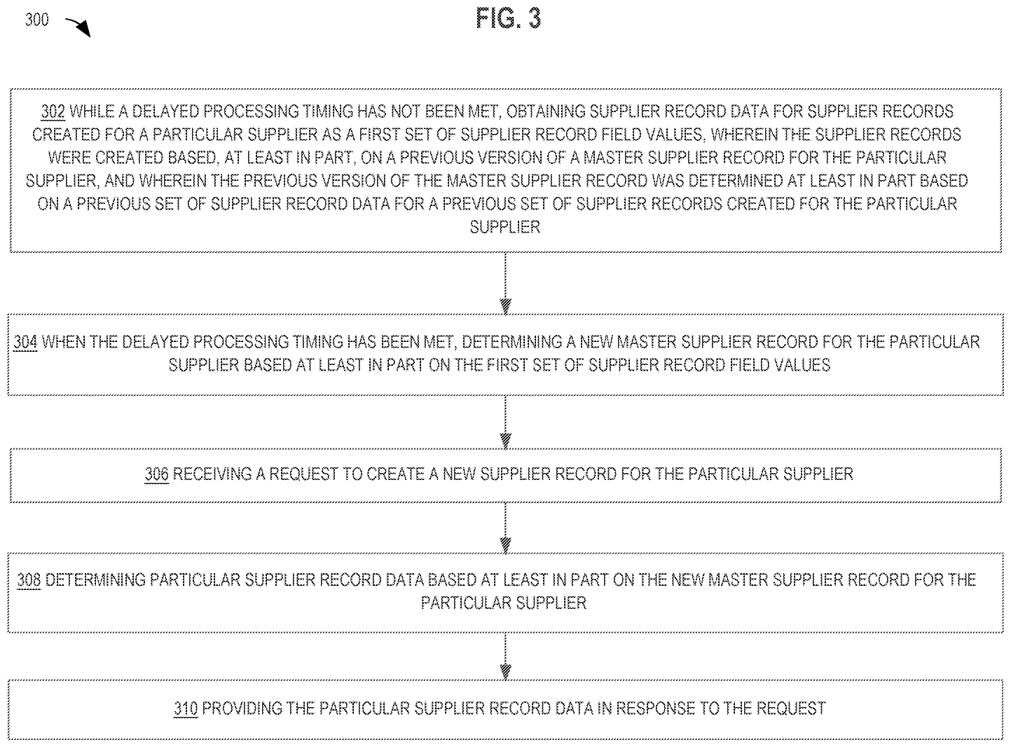

FIG. 3 illustrates an algorithm or method 300 for batch processing supplier records, according to various embodiments. For purposes of illustrating a clear example, FIG. 3 is described herein in the context of FIG. 1, but the broad principles of FIG. 3 can be applied to other systems having configurations other than as shown in FIG. 1. Further, FIG. 3 and each other flow diagram herein illustrates an algorithm or plan that may be used as a basis for programming one or more of the functional modules of FIG. 1 that relate to the functions that are illustrated in the diagram, using a programming development environment or programming language that is deemed suitable for the task. Thus, FIG. 3 and each other flow diagram herein are intended as an illustration at the functional level at which skilled persons, in the art to which this disclosure pertains, communicate with one another to describe and implement algorithms using programming. The flow diagrams are not intended to illustrate every instruction, method object or sub step that would be needed to program every aspect of a working program, but are provided at the high, functional level of illustration that is normally used at the high level of skill in this art to communicate the basis of developing working programs.

FIG. 3 begins at step 302 when a delayed processing timing has not been met. The delayed processing timing may be, for example, a predetermined time or time interval in seconds, minutes, hours, days, weeks, or any other period of time. While the delayed processing timing has not yet been met, the server computer 102 obtains supplier record data for supplier records for a particular supplier as a set of supplier record field values. In an embodiment, a variety of different buyer computers 112 may use an e-procurement system to generate supplier records during the onboarding process. A supplier record may be, for example, a form featuring multiple fields and associated field values that represent data for a specific supplier. Data that is entered into these forms may include, for example, the name and address of the supplier, tax information such as a tax identification and/or whether the supplier is a minority owned company. Any number of fields and associated field values may be used to gather any amount of relevant information for onboarding purposes.

In an embodiment, the e-procurement system may access existing data stored in the data repository 110 to auto-populate the supplier record fields with relevant data. For example, the e-procurement system may access a previous version of a master supplier record for a specific supplier. The master supplier record may be, for example, a compilation of all data pertaining to a particular supplier. Any number of master records for any number of suppliers may be stored in the data repository 110. These previous versions of master records for particular suppliers may have been determined, at least in part, based on previous sets of supplier record data for previous sets of supplier records pertaining to a particular supplier. For example, a number of other buyer computers 112 may have submitted previous supplier record forms with fields featuring previous supplier record data that was then used to generate these previous master supplier records. The data from these previous master supplier records may be used to auto-populate the supplier record fields of a variety of supplier records while the delayed processing time has not yet been met.

However, at step 304, when the delayed processing time has been met, the server computer 102 may determine a new master supplier record for a particular supplier based, at least in part, on the set of supplier record field values obtained at step 302. In an embodiment, the server computer 102 gathers multiple current supplier records until the delayed processing time has been met. Subsequently, the server computer 102 generates a new master supplier record using any combination of current and past data. For example, the new master supplier record may be generated using a combination of current supplier record field values, previous supplier record field values, and/or a previous master supplier record data. For example, the server computer 102 may use a previous master supplier record and all associated data as a template and update the data using the most recent field values obtained at step 302 in order to generate a new master supplier record.

In an embodiment, in order to generate the new master supplier record, the server computer 102 may cross-reference one or more supplier records with the previous master supplier record to identify changes in data. For example, if the server computer 102 received five supplier records for Supplier A before the delayed processing time was met, the server computer 102 may cross-reference data from the five supplier records with data from the previous master supplier record to identify changes in data. If no changes are detected, then the server computer 102 may use the previous master supplier record as the new master supplier record. If changes are detected, then the server computer 102 may update the previous master supplier record to generate the new master supplier record.

At step 306, the server computer 102 receives a request to create a new supplier record for the particular supplier. For example, the request may be from a buyer computer 112 using the e-procurement system to generate a new supplier record for Supplier A during an onboarding process. In an embodiment, the supplier entity may be an existing entity that has already been entered into the e-procurement system and is associated with existing supplier records and/or master supplier record. For example, the server computer 102 may access existing supplier records and/or a master supplier record for Supplier A from previous transactions with other buyer entities.

At step 308, the server computer 102 determines particular supplier record data based, as least in part, on the new master supplier record for the particular supplier. In an embodiment, in response to receiving the request to create a new supplier record at step 306, the server computer may access the master supplier record that is stored in an associated database and use the master supplier record to identify data pertaining to particular supplier records that may be used to auto-populate various fields of the new supplier record. For example, in response to receiving a request to create a new supplier record for Supplier A, the server computer 102 may access the new master supplier record for Supplier A and use the data from the new master supplier record to auto-populate various fields in the new supplier record for Supplier A. Data from the previous master suppliers, supplier records, and/or previous supplier records may also be used.

In an embodiment, the server computer 102 may use one or more weighted factors to determine which data from the new master supplier record, previous master supplier records, supplier records, and/or previous sets of supplier records to recommend for use in the new supplier record. In an embodiment, the weighted factors include a confidence value, a frequency value, a recency value, or any other factor. For example, each supplier record field value of each supplier record may be assigned a frequency value, recency value, and/or confidence value that is then used to determine what data should be recommended and auto-populated for the new supplier record. In another embodiment, field values of previous supplier records, previous master records, and/or new master supplier records may also be assigned frequency values, recency values, confidence values, or any other factors for determining recommendations.

In an embodiment, to determine the frequency value, the server computer 102 may evaluate the frequency with which specific data, such as specific mailing addresses, appear between previous supplier records, supplier records, previous master supplier records, and/or the new master supplier record. For example, if Supplier A has five associated supplier records, and four of the five supplier records indicate the same mailing address for Supplier A, the server computer 102 may generate a frequency value based on the number of times the same address appears. The higher the frequency value, the more likely the server computer 102 will recommend and auto-populate the new supplier record field for the mailing address for Supplier A with the same address. The lower the frequency value, the less likely the server computer 102 will recommend and auto-populate the new supplier record field for the mailing address for Supplier A with the same address. In an embodiment, a frequency threshold may be set such that only data that has met the threshold may be recommended and auto-populated.

To determine the recency value, the server computer 102 may evaluate the recency with which data appear between previous supplier records, supplier records, previous master supplier records, and/or the new master supplier record. For example, if three of the most recent previous master supplier records out of six total previous master supplier records indicate a specific mailing address for Supplier A, the server computer 102 may generate a recency value that ranks the address featured in the three more recent previous master supplier records higher than the address featured in the three least recent previous master supplier records. The higher the recency value, the more likely the server computer 102 will recommend and auto-populate the new supplier record field for the mailing address for Supplier A with any specific mailing address. The lower the recency value, the less likely the server computer 102 will recommend and auto-populate the new supplier record field for the mailing address for Supplier A with any specific mailing address. In an embodiment, a recency threshold may be set such that only data that has met the threshold may be recommended and auto-populated.

The server computer 102 may also evaluate a confidence value for the data. The confidence value may be, for example, a value indicating a level of machine confidence that the data is accurate. In an embodiment, the confidence value may be determined using, for example, the frequency value, recency value, and/or any other factors. In the example above, the frequency value and the recency value generated for the mailing address field for Supplier A may be combined to determine an overall confidence value for specific mailing address data. In an embodiment, the higher the confidence value, the more likely the server computer 102 will recommend and auto-populate the new supplier record field for the mailing address for Supplier A with any specific mailing address. The lower the confidence value, the less likely the server computer 102 will recommend and auto-populate the new supplier record field for the mailing address for Supplier A with any specific mailing address. In an embodiment, a confidence threshold may be set such that only data that has met the threshold may be recommended and auto-populated.

In an embodiment, in response to determining the particular supplier record data to recommend and auto-populate, the server computer 102 may automatically generate and send a confirmation request to a supplier computer 116. The confirmation request may comprise the particular supplier record data as a second set of supplier record field values. For example, the server computer 102 may use the frequency, recency, and confidence values and/or thresholds to automatically generate and send a recommended new supplier record with various fields auto-populated with value recommendations from step 308. The supplier computer 116 may subsequently confirm or change the recommended data featured in recommended new supplier record.

The server computer 102 may receive input from the supplier computer 116 in response to sending the confirmation request. The input may confirm or change the second set of supplier record field values. For example, the supplier computer 116 may generate and send input that confirms the recommended new supplier record field values through a one-click confirmation. The supplier computer 116 may also generate and send input that changes or updates the recommended new supplier record field values. In an embodiment, the input may then be used to provide supplier record data to the buyer computer 112.

At step 310, the server computer 102 may provide the supplier record data in response to the request received at step 306. The supplier record data may also be provided to the buyer computer 112 in response to the input confirming or changing the supplier record field values. For example, if the supplier computer 116 confirmed the recommended new supplier record data, the server computer 102 may provide the recommended new supplier record to the buyer computer 112 based on the confirmed input from the supplier computer 116. In another embodiment, if the supplier computer 116 changed the recommended new supplier record data, the server computer 102 may provide the updated new supplier record to the buyer computer 112 based on the changed input from the supplier computer 116. The server computer 102 may cause any of the above data to be displayed through a buyer computer's display using a Graphical User Interface (GUI). For example, the server computer 102 may cause the recommended new supplier record and all associated data to be displayed in a GUI through the e-procurement system.

Although some of the figures described in the specification include flow diagrams with steps that are shown in an order, the steps may be performed in any order, and are not limited to the order shown in those flowcharts. Additionally, some steps may be optional, may be performed multiple times, and/or may be performed by different components. All steps, operations and functions of a flow diagram that are described herein are intended to indicate operations that are performed using programming in a special-purpose computer or general-purpose computer, in various embodiments. In other words, each flow diagram in this disclosure, in combination with the related text herein, is a guide, plan or specification of all or part of an algorithm for programming a computer to execute the functions that are described. The level of skill in the field associated with this disclosure is known to be high, and therefore the flow diagrams and related text in this disclosure have been prepared to convey information at a level of sufficiency and detail that is normally expected in the field when skilled persons communicate among themselves with respect to programs, algorithms and their implementation.

The example embodiment(s) of the present invention described in this specification have been described with reference to numerous specific details. However, the details may vary from implementation to implementation according to the requirements of the particular implement at hand. The example embodiment(s) are, accordingly, to be regarded in an illustrative rather than a restrictive sense.

Techniques are provided for automated batch processing of suppler information management records and supplier record data to improve computer resource usage with regards to e-procurement transactions. In past approaches, supplier data for each supplier was collected and entered independently by a variety of buyers and/or suppliers during an on-boarding process. This created the duplication of effort that resulted in excessive and unnecessarily wasteful use of processing resources, such as CPU cycles, and network bandwidth. Current techniques provide for accurate assessment of supplier information without duplication of effort, thereby providing the benefit of saving processing resources and network bandwidth.

### 5.0 Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

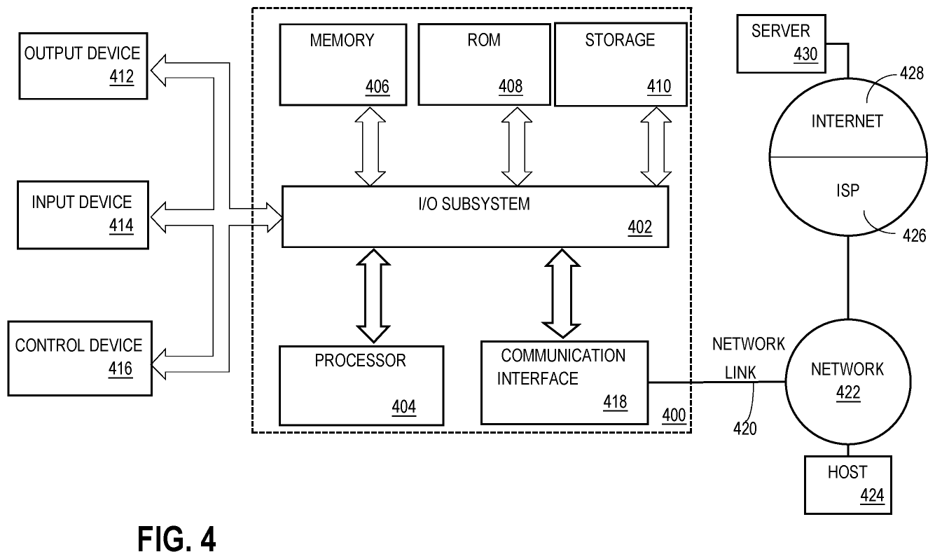

FIG. 4 is a block diagram that illustrates an example computer system with which an embodiment may be implemented. In the example of FIG. 4, a computer system 400 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 400 includes an input/output (I/O) subsystem 402 which may include a bus and/or other communication mechanism(s) for communicating information and/or instructions between the components of the computer system 400 over electronic signal paths. The I/O subsystem 402 may include an I/O controller, a memory controller and at least one I/O port. The electronic signal paths are represented schematically in the drawings, for example as lines, unidirectional arrows, or bidirectional arrows.

At least one hardware processor 404 is coupled to I/O subsystem 402 for processing information and instructions. Hardware processor 404 may include, for example, a general-purpose microprocessor or microcontroller and/or a special-purpose microprocessor such as an embedded system or a graphics processing unit (GPU) or a digital signal processor or ARM processor. Processor 404 may comprise an integrated arithmetic logic unit (ALU) or may be coupled to a separate ALU.

Computer system 400 includes one or more units of memory 406, such as a main memory, which is coupled to I/O subsystem 402 for electronically digitally storing data and instructions to be executed by processor 404. Memory 406 may include volatile memory such as various forms of random-access memory (RAM) or other dynamic storage device. Memory 406 also may be used for storing temporary variables or other intermediate information during execution of instructions to be executed by processor 404. Such instructions, when stored in non-transitory computer-readable storage media accessible to processor 404, can render computer system 400 into a special-purpose machine that is customized to perform the operations specified in the instructions.

Computer system 400 further includes non-volatile memory such as read only memory (ROM) 408 or other static storage device coupled to I/O subsystem 402 for storing information and instructions for processor 404. The ROM 408 may include various forms of programmable ROM (PROM) such as erasable PROM (EPROM) or electrically erasable PROM (EEPROM). A unit of persistent storage 410 may include various forms of non-volatile RAM (NVRAM), such as FLASH memory, or solid-state storage, magnetic disk or optical disk such as CD-ROM or DVD-ROM and may be coupled to I/O subsystem 402 for storing information and instructions. Storage 410 is an example of a non-transitory computer-readable medium that may be used to store instructions and data which when executed by the processor 404 cause performing computer-implemented methods to execute the techniques herein.

The instructions in memory 406, ROM 408 or storage 410 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 400 may be coupled via I/O subsystem 402 to at least one output device 412. In one embodiment, output device 412 is a digital computer display. Examples of a display that may be used in various embodiments include a touch screen display or a light-emitting diode (LED) display or a liquid crystal display (LCD) or an e-paper display. Computer system 400 may include other type(s) of output devices 412, alternatively or in addition to a display device. Examples of other output devices 412 include printers, ticket printers, plotters, projectors, sound cards or video cards, speakers, buzzers or piezoelectric devices or other audible devices, lamps or LED or LCD indicators, haptic devices, actuators or servos.

At least one input device 414 is coupled to I/O subsystem 402 for communicating signals, data, command selections or gestures to processor 404. Examples of input devices 414 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 416, which may perform cursor control or other automated control functions such as navigation in a graphical interface on a display screen, alternatively or in addition to input functions. Control device 416 may be a touchpad, a mouse, a trackball, or cursor direction keys for communicating direction information and command selections to processor 404 and for controlling cursor movement on display 412. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 414 may include a combination of multiple different input devices, such as a video camera and a depth sensor.

In another embodiment, computer system 400 may comprise an internet of things (IoT) device in which one or more of the output device 412, input device 414, and control device 416 are omitted. Or, in such an embodiment, the input device 414 may comprise one or more cameras, motion detectors, thermometers, microphones, seismic detectors, other sensors or detectors, measurement devices or encoders and the output device 412 may comprise a special-purpose display such as a single-line LED or LCD display, one or more indicators, a display panel, a meter, a valve, a solenoid, an actuator or a servo.

When computer system 400 is a mobile computing device, input device 414 may comprise a global positioning system (GPS) receiver coupled to a GPS module that is capable of triangulating to a plurality of GPS satellites, determining and generating geo-location or position data such as latitude-longitude values for a geophysical location of the computer system 400. Output device 412 may include hardware, software, firmware and interfaces for generating position reporting packets, notifications, pulse or heartbeat signals, or other recurring data transmissions that specify a position of the computer system 400, alone or in combination with other application-specific data, directed toward host 424 or server 430.

Computer system 400 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 400 in response to processor 404 executing at least one sequence of at least one instruction contained in main memory 406. Such instructions may be read into main memory 406 from another storage medium, such as storage 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 410. Volatile media includes dynamic memory, such as memory 406. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 402. Transmission media can also take the form of acoustic or light waves, such as those generated during radio-wave and infra-red data communications.

Various forms of media may be involved in carrying at least one sequence of at least one instruction to processor 404 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 400 can receive the data on the communication link and convert the data to a format that can be read by computer system 400. For instance, a receiver such as a radio frequency antenna or an infrared detector can receive the data carried in a wireless or optical signal and appropriate circuitry can provide the data to I/O subsystem 402 such as place the data on a bus. I/O subsystem 402 carries the data to memory 406, from which processor 404 retrieves and executes the instructions. The instructions received by memory 406 may optionally be stored on storage 410 either before or after execution by processor 404.

Computer system 400 also includes a communication interface 418 coupled to bus 402. Communication interface 418 provides a two-way data communication coupling to network link(s) 420 that are directly or indirectly connected to at least one communication networks, such as a network 422 or a public or private cloud on the Internet. For example, communication interface 418 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 422 broadly represents a local area network (LAN), wide-area network (WAN), campus network, internetwork or any combination thereof. Communication interface 418 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 418 sends and receives electrical, electromagnetic or optical signals over signal paths that carry digital data streams representing various types of information.

Network link 420 typically provides electrical, electromagnetic, or optical data communication directly or through at least one network to other data devices, using, for example, satellite, cellular, Wi-Fi, or BLUETOOTH technology. For example, network link 420 may provide a connection through a network 422 to a host computer 424.

Furthermore, network link 420 may provide a connection through network 422 or to other computing devices via internetworking devices and/or computers that are operated by an Internet Service Provider (ISP) 426. ISP 426 provides data communication services through a world-wide packet data communication network represented as internet 428. A server computer 430 may be coupled to internet 428. Server 430 broadly represents any computer, data center, virtual machine or virtual computing instance with or without a hypervisor, or computer executing a containerized program system such as DOCKER or KUBERNETES. Server 430 may represent an electronic digital service that is implemented using more than one computer or instance and that is accessed and used by transmitting web services requests, uniform resource locator (URL) strings with parameters in HTTP payloads, API calls, app services calls, or other service calls. Computer system 400 and server 430 may form elements of a distributed computing system that includes other computers, a processing cluster, server farm or other organization of computers that cooperate to perform tasks or execute applications or services. Server 430 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 430 may comprise a web application server that hosts a presentation layer, application layer and data storage layer such as a relational database system using structured query language (SQL) or no SQL, an object store, a graph database, a flat file system or other data storage.

Computer system 400 can send messages and receive data and instructions, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage 410, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 404. While each processor 404 or core of the processor executes a single task at a time, computer system 400 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

What is claimed is:

1. A computer-implemented method, comprising:
while a delayed processing timing has not been met, obtaining supplier record data for supplier records created for a particular supplier as a first set of supplier record field values, wherein the supplier records were created based, at least in part, on a previous version of a master supplier record for the particular supplier, and wherein the previous version of the master supplier record was determined, at least in part, based on a previous set of supplier record data for a previous set of supplier records created for the particular supplier;
when the delayed processing timing has been met, determining a new master supplier record for the particular supplier based, at least in part, on the first set of supplier record field values;
receiving a request to create a new supplier record for the particular supplier;
determining particular supplier record data based, at least in part, on the new master supplier record for the particular supplier; and
providing the particular supplier record data in response to the request,
wherein the computer-implemented method is performed by one or more computing devices.

2. The computer-implemented method of claim 1, wherein determining the new master supplier record for the particular supplier is further based, at least in part, on one or more of the previous set of supplier record data for the previous set of supplier records or the previous version of the master supplier record.

3. The computer-implemented method of claim 1, wherein determining the particular supplier record data is further based, at least in part, on the request to create the new supplier record for the particular supplier.

4. The computer-implemented method of claim 1, further comprising:
in response to determining the particular supplier record data, automatically generating and sending a confirmation request comprising the particular supplier record data as a second set of supplier record field values to a supplier computing device; and
in response to sending the confirmation request, receiving input from the supplier computing device confirming or changing the second set of supplier record field values.

5. The computer-implemented method of claim 1, wherein the particular supplier record data comprises calculating a confidence value for each of the first set of supplier record field values and selecting the particular supplier record data based on the confidence value for each of the first set of supplier record field values.

6. The computer-implemented method of claim 1, wherein determining the particular supplier record data comprises calculating a recency value for each of the first set of supplier record field values and selecting the particular supplier record data based on the recency value for each of the first set of supplier record field values.

7. The computer-implemented method of claim 1, wherein determining the particular supplier record data comprises calculating a frequency value for each of the first set of supplier record field values and selecting the particular supplier record data based on the frequency value for each of the first set of supplier record field values.

8. A non-transitory computer-readable storage medium storing instructions which, when
executed by one or more processors, cause:
while a delayed processing timing has not been met, obtaining supplier record data for supplier records created for a particular supplier as a first set of supplier record field values, wherein the supplier records were created based, at least in part, on a previous version of a master supplier record for the particular supplier, and wherein the previous version of the master supplier record was determined, at least in part, based on a previous set of supplier record data for a previous set of supplier records created for the particular supplier;
when the delayed processing timing has been met, determining a new master supplier record for the particular supplier based, at least in part, on the first set of supplier record field values;
receiving a request to create a new supplier record for the particular supplier;
determining particular supplier record data based, at least in part, on the new master supplier record for the particular supplier; and
providing the particular supplier record data in response to the request.

9. The non-transitory computer-readable storage medium of claim 8, storing instructions which, when executed by one or more processors, further cause:
wherein determining the new master supplier record for the particular supplier is further based, at least in part, on one or more of the previous set of supplier record data for the previous set of supplier records or the previous version of the master supplier record.

10. The non-transitory computer-readable storage medium of claim 9, wherein determining the particular supplier record data is further based, at least in part, on the request to create the new supplier record for the particular supplier.

11. The non-transitory computer-readable storage medium of claim 9, storing instructions
which, when executed by one or more processors, further cause:
in response to determining the particular supplier record data, automatically generating and sending a confirmation request comprising the particular supplier record data as a second set of supplier record field values to a supplier computing device; and
in response to sending the confirmation request, receiving input from the supplier computing device confirming or changing the second set of supplier record field values.

12. The non-transitory computer-readable storage medium of claim 8, wherein determining the particular supplier record data comprises calculating a confidence value for each of the first set of supplier record field values and selecting the particular supplier record data based on the confidence value for each of the first set of supplier record field values.

13. The non-transitory computer-readable storage medium of claim 8, wherein determining the particular supplier record data comprises calculating a recency value for each of the first set of supplier record field values and selecting the particular supplier record data based on the recency value for each of the first set of supplier record field values.

14. The non-transitory computer-readable storage medium of claim 8, wherein determining the particular supplier record data comprises calculating a frequency value for each of the first set of supplier record field values and selecting the particular supplier record data based on the frequency value for each of the first set of supplier record field values.

15. A computer system, comprising:
a server computing device having one or more first processors and first storage media storing first instructions for execution by the one or more first processors of the server computing device;
a buyer computing device having one or more second processors and second storage media storing second instructions for execution by the one or more second processors of the buyer computing device;
wherein the first instructions are configured for:
while a delayed processing timing has not been met, obtaining supplier record data for supplier records created for a particular supplier as a first set of supplier record field values, wherein the supplier records were created based, at least in part, on a previous version of a master supplier record for the particular supplier, and wherein the previous version of the master supplier record was determined, at least in part, based on a previous set of supplier record data for a previous set of supplier records created for the particular supplier;
when the delayed processing timing has been met, determining a new master supplier record for the particular supplier based, at least in part, on the first set of supplier record field values;
receiving a request to create a new supplier record for the particular supplier;
determining particular supplier record data based, at least in part, on the new master supplier record for the particular supplier; and
providing the particular supplier record data in response to the request.

16. The computer system of claim 15, further comprising:
a supplier computing device having one or more third processors and third storage media storing third instructions for execution by the one or more third processors of the supplier computing device;
wherein the first instructions are further configured for:
in response to determining the particular supplier record data, automatically generating and sending a confirmation request comprising the particular supplier record data as a second set of supplier record field values to the supplier computing device; and wherein the third instructions are configured for:
in response to receiving the confirmation request, sending input confirming or changing the second set of supplier record field values.

17. The computer system of claim 16, wherein determining the particular supplier record data comprises calculating a confidence value for each of the first set of supplier record field values and selecting the particular supplier record data based on the confidence value for each of the first set of supplier record field values.

18. The computer system of claim 17, wherein the first instructions are further configured for:
obtaining the input confirming or changing the second set of supplier record field values; and
calculating an updated confidence value based on the input.

19. The computer system of claim 18, wherein determining the particular supplier record data comprises calculating a recency value for each of the first set of supplier record field values and selecting the particular supplier record data based on the recency value for each of the first set of supplier record field values.

20. The computer system of claim 19, wherein determining the particular supplier record data comprises calculating a frequency value for each of the first set of supplier record field values and selecting the particular supplier record data based on the frequency value for each of the first set of supplier record field values.
